(19) United States
(12) Patent Application Publication
(10) Pub. No.: US 2020/0063902 A1
(43) Pub. Date: Feb. 27, 2020

(54) Connecting Assembly and Method for Manufacturing Thereof

(71) Applicant: Tucai, S.A., Barbera del Valles (ES)

(72) Inventors: Daniel Granados Niubo, Barbera del Valles (ES); Oscar Antonijuan Gispert, Barbera del Valles (ES)

(73) Assignee: Tucai, S.A., Barbera del Valles (ES)

(21) Appl. No.: 16/367,996

(22) Filed: Mar. 28, 2019

(30) Foreign Application Priority Data
Aug. 23, 2018 (ES) P201830836

(51) Int. Cl. F16L 33/32

(52) U.S. Cl. CPC F16L 33/32

(57) ABSTRACT

A connecting assembly and method for manufacturing thereof, said assembly being intended for a fluid conduit facility, comprising at the least a tubular member made of flexible plastic material intended for the circulation of a fluid through it, at the least a substrate that surrounds the tubular member having a braided mesh configuration and a connecting member attached in at least one of the ends of the tubular member, wherein said connecting member is made up of a plastic material moldable by injection, being encapsulated at the end of a set formed by the tubular member and the substrate.

### CROSS-REFERENCE TO RELATED APPLICATIONS

This application claims priority from ES Patent Application No. P201830836, filed Aug. 23, 2018, the disclosure of which is incorporated herein by reference.

### BACKGROUND OF THE INVENTION

The present invention relates to a connecting assembly intended for a fluid conduit facility, as well as a method for manufacturing a connecting assembly.

In the field of sanitary facilities, it is well known to use flexible pipes intended for connecting, for example, the pipes of a sanitary water pipe in the wall with a sanitary outlet fitting mounted in a sink. A typical arrangement is one that is formed by an inner tube and a braided coating intended to maintain the integrity of the conductive tube under a pressure, either of the operating pressures or overpressures generated by the closure of the valve, such as, for example, the effect of water hammer.

In order to carry out the connection of the flexible tube at both ends, metal fittings are available which can have different geometries, while all of them are usually based on the connection of the flexible member in a thread way with both connection points.

The attachment of the assembly formed by the different members of the tube, such as the metal fitting, the inner tube and the outer tube, is achieved by a mechanical connection, in this case, by mechanical pressing of the three members by means of a metal flange. The assembly operation of the flange is a calibrated compression process that has to guarantee the perfect attachment of the different materials that make up the assembly, being a critical aspect of the assembly, since a water-tightness free of any leakage has to be guaranteed.

In any case, all connection systems consist of a mechanical type connection through the application of pressure between the terminals of the mounting tubes. Therefore, there is a need to find alternative solutions that ensure a water-tightness in a simpler way, without mechanical components, thus reducing the number of members and simplifying the manufacturing process.

An additional drawback found in this connection system is the creation of oxidation in the outermost tube (braided tubular member), whereby reduces the useful life of the system or implies the withdrawal of the product from the point of sale.

In addition, the applicant is currently unaware of the existence of an invention having all the characteristics described herein.

### SUMMARY OF THE INVENTION

The present invention was developed with the aim of providing a connecting assembly that constitutes a novelty within the field of application, and solves the disadvantages mentioned above while also contributing other additional advantages, which will become evident from the description provided below.

It is therefore an object of the present invention to provide a connecting assembly, intended to a fluid conduit facility, comprising a tubular member made of flexible plastic material intended for the circulation of a fluid through it, substrate that surrounds the tubular member having a braided mesh configuration and a connecting member attached in at least one of the ends of the tubular member, characterized in that the connecting member is made up of a plastic material moldable by injection, being encapsulated at the end of a set formed by the tubular member and the substrate.

Advantageously, the braided mesh defines a plurality of interstices, such that each interstice has a minimum surface area of 0.04 mm2. The presence of these interstices increases the mechanical anchoring in order to obtain a sufficient and adequate performance for the necessary mechanical performance during its use.

Preferably, the braid mesh can be formed by a plurality of wires with a minimum diameter of 0.10 mm.

Therefore, the object of this invention is a connection for flexible tubes (also known in the field as flexible hoses) based on a flexible connection system manufactured entirely with polymeric materials linked through techniques known in the current art, but in no case applied for this type of connections. In the same way, it implies using of adhesive adhesives is not required, which would imply the provision of special devices.

In addition, it offers as a disruptive member the integration of the tap base itself as part of the system, which allows obtaining a number of 100% sealing of the assembly when all the components (inner tube, outer mesh, connectors and base of the taps) define a single integral and watertight body, by means of the adhesion by over-injection of all the members and corresponding polymeric materials.

It is also another object of the invention to provide a method for manufacturing a connecting assembly, wherein it comprises a tubular member of flexible material intended to the circulation of a fluid through it, a substrate that surrounds the tubular member having a braided mesh configuration and a connecting member attached in at least one of the ends of the tubular member, characterized in that it comprises:

placing the tubular member and the substrate in a mold intended to injection molding;

encapsulating an injection-moldable plastic material onto an end portion of the assembly formed by the tubular member and the substrate for forming the connecting member, such that the tubular member and the substrate are partially inserted tightly into a through hole located in the connecting member.

The advantage of using encapsulating molding using the substrate insert is that conventional injection machines can be used to decrease manufacturing costs, the removal of metal components as well as the removal of mechanical joints capable of compromising the tightness of the assembly.

According to another aspect of the invention, the tubular member has a protruding portion that is not surrounded by the substrate, so that the protruding portion is covered by a region of plastic material that is a part of the connecting member. This arrangement makes it possible to ensure tightness since the fact of having this protruding portion devoid of the substrate allows for the diffusion of the material forming part of the tubular member and the connecting member.

Other characteristics and advantages of the connecting assembly, object of the present invention, will become clear in light of the description of a preferred, though non-exclusive, embodiment, which, by way of a non-limiting example, is illustrated in the accompanying drawings, wherein:

### BRIEF DESCRIPTION OF THE DRAWINGS

FIG. 1 is a side elevation view of the connecting assembly according to the present invention;

FIG. 2 is a view in longitudinal section of a portion of the connecting assembly;

FIG. 3 is a detailed elevation view wherein the connecting member has been deleted for sakes of clarity; and

FIG. 4 is a detailed elevation view of the circle shown in FIG. 3.

### DESCRIPTION OF THE PREFERRED EMBODIMENT

In view of the aforementioned figures and, in accordance with the numbering adopted, an example of a preferred embodiment of the invention can be observed therein, which comprises the parts and elements indicated and described in detail below.

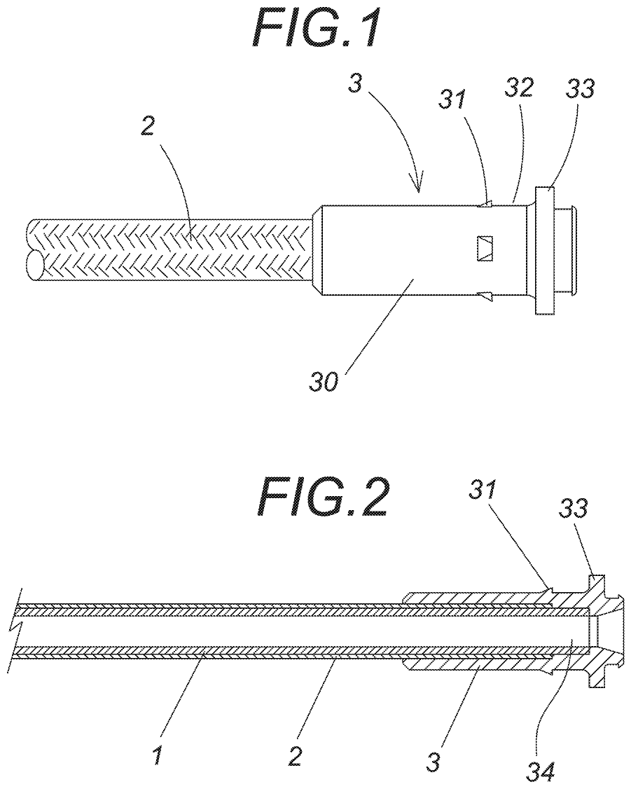

As shown in FIGS. 1 and 2, an embodiment of the connecting assembly of the invention, being intended to a fluid conduit facility, comprises a tubular member (1) as a conduit made of plastic and flexible material intended to the circulation of a fluid through it, a substrate (2) that surrounds the tubular member (1) having a braided mesh configuration and a connecting member (3) attached in at least one of the ends of the tubular member (3) intended to be coupled, for example, to the inlet of a conventional tap (not shown).

The tubular member (1) can be, for example, made up of EPDM (ethylene propylene diene monomer).

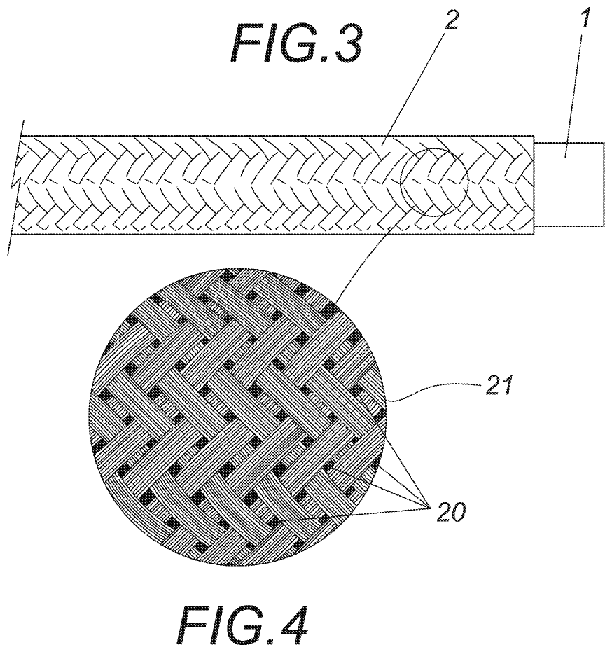

Advantageously, the braided mesh formed in the substrate (2) is essentially defined by a plurality of interstices (see FIGS. 3 and 4), such that each interstice (20) has a minimum surface area of 0.04 mm2. In addition, the braid mesh is formed by a plurality of wires (21) with a minimum diameter of 0.10 mm.

The outermost substrate (2) guarantees the maintenance of the geometry of the tubular member (1) even under pressure and temperature conditions since it provides a radial reinforcement without limiting the flexibility of the tubular member (1).

Now with particular reference to the connecting member (3), it is made up of an injection moldable plastic material, being encapsulated at the end of a set formed by the tubular member (3) and the substrate (2). For the encapsulation, techniques and means currently known in the state of the art are used in the field of molding by encapsulation, for this reason it is not going to do a more detailed description.

More particularly, it is formed by an elongated body (30) of substantially cylindrical shape provided with a through hole (34), the hole being gradually widened at its end facing outwardly, and including a fixing means (which are described below) that facilitates a snap-fit connection with the connection arranged in the conventional taps.

In this embodiment by way of non-limiting example, the fixing means has a plurality of wedge-shaped flanges (31), such flanges being arranged radially around the body forming the connecting member and defining a coupling region (32) delimited by such flanges (31) and a circumferential protrusion (33) projecting perimetrally outwardly from the side wall of the connecting member (3).

The details, shapes, dimensions and other accessory members used to manufacture the connecting assembly of the invention may be suitably substituted for others which do not diverge from the scope defined by the claims included below.

1. A connecting assembly, intended for a fluid conduit facility, comprising at the least a tubular member (1) made of flexible plastic material intended to the circulation of a fluid through it, at the least a substrate (2) that surrounds the tubular member having a braided mesh configuration and a connecting member (3) attached in at least one of the ends of the tubular member (1), characterized in that the connecting member (3) is made up of a plastic material moldable by injection, being encapsulated at the end of a set formed by the tubular member (1) and the substrate (2).

2. The connecting assembly according to claim 1, characterized in that the braided mesh defines a plurality of interstices, such that each interstice has a minimum surface area of 0.04 mm2.

3. The connecting assembly according to any of the preceding claims, characterized in that the braid mesh is formed by a plurality of wires (21) with a minimum diameter of 0.10 mm.

4. The connecting assembly according to any of the preceding claims, characterized in that connecting member (3) is formed by a substantially cylindrical-shaped elongated body provided with a through hole (34), the hole being gradually widened at its end facing outwardly, and including a fixing means.

5. The connecting assembly according to claim 4, characterized in that the fixing means comprises a plurality of wedge-shaped flanges (31), such flanges being arranged radially around the body forming the connecting member (3).

6. A method for manufacturing a connecting assembly, wherein it comprises a tubular member of flexible material intended for the circulation of a fluid through it, a substrate that surrounds the tubular member having a braided mesh configuration and a connecting member attached in at least one of the ends of the tubular member, characterized in that it comprises:
placing the tubular member and the substrate in a mold intended for injection molding;
encapsulating an injection-moldable plastic material onto an end portion of the assembly formed by the tubular member and the substrate for forming the connecting member, such that the tubular member and the substrate are partially inserted tightly into a through hole located in the connecting member.

7. The method according to claim 6, characterized in that the tubular member has a protruding portion that is not surrounded by the substrate, so that the protruding portion is covered by a region of plastic material that is a part of the connecting member.
